(19) United States
(12) Patent Application Publication
(10) Pub. No.: US 2024/0109435 A1
(43) Pub. Date: Apr. 4, 2024

(54) POWER STORAGE SYSTEM

(71) Applicant: HONDA MOTOR CO., LTD., Tokyo (JP)

(72) Inventors: Yasushi OGIHARA, Saitama (JP); Yasuo YAMADA, Saitama (JP); Yoshio KOJIMA, Saitama (JP); Harumi TAKEDOMI, Saitama (JP)

(73) Assignee: HONDA MOTOR CO., LTD., Tokyo (JP)

(21) Appl. No.: 18/373,031

(22) Filed: Sep. 26, 2023

(30) Foreign Application Priority Data
Sep. 30, 2022 (JP) 2022-157933

(51) Int. Cl. B60L 50/51; B60L 50/60; H02J 7/00

(52) U.S. Cl. CPC B60L 50/51; B60L 50/66; H02J 7/0068; H02J 2207/10

(57) ABSTRACT

A power storage system includes a battery including a first power storage unit, a second power storage unit, and a first switch unit, a three-phase motor in which coils of three phases are connected at a neutral point, the three-phase motor being driven by electric power supplied from the battery, an inverter connected on an electric power transmission path between the battery and the three-phase motor, and a DC power supply circuit connected to a connection portion located on an electric power transmission path between the inverter and the battery. The DC power supply circuit includes a branch circuit connected to the neutral point on a positive electrode side.

### CROSS-REFERENCE TO RELATED APPLICATIONS

This application is based on and claims priority under 35 USC 119 from Japanese Patent Application No. 2022-157933 filed on Sep. 30, 2022.

### TECHNICAL FIELD

The present disclosure relates to a power storage system.

### BACKGROUND ART

In recent years, researches and developments have been conducted on charging and power supply in a vehicle including a secondary battery which contributes to energy efficiency in order to allow more people to have access to affordable, reliable, sustainable and advanced energy.

In relation to charging and power supply in a vehicle including a secondary battery, there are two types of charging equipment such as charge stations which are compatible with 400 V class and 800 V class, respectively. When a vehicle is compatible with only the 400 V class charging equipment, the vehicle cannot enjoy quick charging performance of the 800 V class charging equipment by the 800 V class charging equipment.

In a case where the vehicle is both compatible with the 400 V class charging equipment and the 800 V class charging equipment, generally, a voltage is boosted to 800 V by a voltage converter when charging by the 400 V class charging equipment, or the voltage is stepped down to 400 V by the voltage converter when charging by the 800 V class charging equipment. However, using such voltage converter for charging deteriorates efficiency during charging.

In this regard, there is known a vehicle which switches a connection system of a battery module so as to be chargeable by both 400 V class charging equipment and 800 V class charging equipment without using any voltage converter for charging (for example, see JP2019-080474A and JP2020-150618A).

In the meantime, there are two types of auxiliary machines used in a vehicle, one is driven at 400 V class and the other one is driven at 800 V class. In the vehicle in which the connection system of the battery module is switched, voltage conversion is generally performed by a voltage converter for an auxiliary machine, for example, when a 400 V class auxiliary machine is driven during charging by the 800 V class charging equipment, or when an 800 V class auxiliary machine is driven during charging by the 400 V class charging equipment. However, such voltage converter for an auxiliary machine is expensive and thus a manufacturing cost increases.

### SUMMARY

An aspect of the present disclosure provides a power storage system which can be efficiently charged according to a voltage state of charging equipment and can reduce a manufacturing cost.

According to an aspect of the present disclosure, there is provided a power storage system including: a battery including a first power storage unit, a second power storage unit, and a first switch unit, the first switch unit being configured to switch between a first voltage state, in which the first power storage unit and the second power storage unit are connected in series and chargeable at a first voltage, and a second voltage state in which the first power storage unit and the second power storage unit are connected in parallel and chargeable at a second voltage; a three-phase motor in which coils of three phases are connected at a neutral point, the three-phase motor being driven by electric power supplied from the battery; an inverter connected on an electric power transmission path between the battery and the three-phase motor; and a DC power supply circuit connected to a connection portion located on an electric power transmission path between the inverter and the battery, in which the DC power supply circuit includes a branch circuit connected to the neutral point on a positive electrode side.

According to the above embodiment, the power storage system can be efficiently charged according to a voltage state of charging equipment and can reduce a manufacturing cost.

### BRIEF DESCRIPTION OF DRAWINGS

FIG. 1 illustrates a configuration of a power storage system 1 according to a first embodiment.

FIG. 2 illustrates a first voltage state (800 V startup) of a battery 2.

FIG. 3 illustrates a second voltage state (400 V startup) of the battery 2.

FIG. 4 illustrates a flow of a current during traveling of an electric vehicle including the power storage system 1 according to the first embodiment.

FIG. 5 illustrates a flow of a current when the electric vehicle including the power storage system 1 according to the first embodiment is charged at a first voltage (800 V).

FIG. 6 illustrates a flow of a current when the electric vehicle including the power storage system 1 according to the first embodiment is charged at a second voltage (400 V).

FIG. 7 illustrates an operation sequence during traveling of the electric vehicle including the power storage system 1 according to the first embodiment.

FIG. 8 illustrates an operation sequence when the electric vehicle including the power storage system 1 according to the first embodiment is charged at the first voltage (800 V).

FIG. 9 illustrates an operation sequence when the electric vehicle including the power storage system 1 according to the first embodiment is charged at the second voltage (400 V).

FIG. 10 illustrates a configuration of an electric vehicle including a power storage system 1 according to a second embodiment.

FIG. 11 illustrates a flow of a current during traveling of the electric vehicle including the power storage system 1 according to the second embodiment.

FIG. 12 illustrates a flow of a current when the electric vehicle including the power storage system 1 according to the second embodiment is charged at a first voltage (800 V).

FIG. 13 illustrates a flow of a current when the electric vehicle including the power storage system 1 according to the second embodiment is charged at a second voltage (400 V).

FIG. 14 illustrates an operation sequence during traveling of the electric vehicle including the power storage system 1 according to the second embodiment.

FIG. 15 illustrates an operation sequence when the electric vehicle including the power storage system 1 according to the second embodiment is charged at the first voltage (800 V).

FIG. 16 illustrates an operation sequence when the electric vehicle including the power storage system 1 according to the second embodiment is charged at the second voltage (400 V).

### DESCRIPTION OF EMBODIMENTS

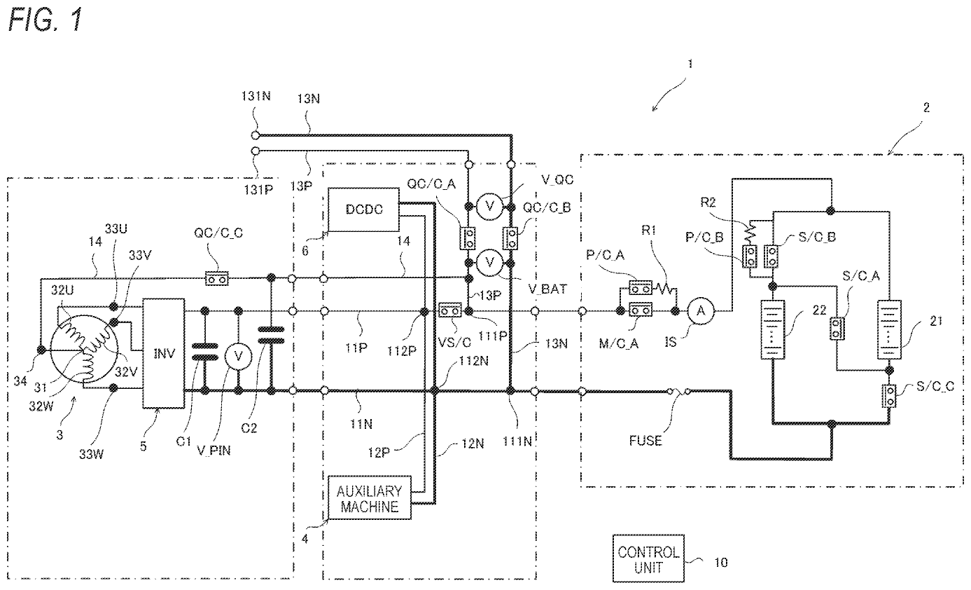

Hereinafter, embodiments of the present disclosure will be described with reference to the drawings. First, a first embodiment according to the present disclosure will be described with reference to FIGS. 1 to 9.

### First Embodiment

A power storage system 1 according to a first embodiment illustrated in FIG. 1 is mounted on an electric vehicle such as an electric automobile. The electric vehicle including the power storage system 1 is compatible with charging equipment of 400 V class and 800 V class. The electric vehicle can not only quickly charge a battery 2 at charge voltages of 400 V and 800 V but also efficiently drive a three-phase motor 3 and an auxiliary machine 4 at a base voltage of 800 V.

Specifically, as illustrated in FIG. 1, the power storage system 1 includes the battery 2, the three-phase motor 3, the auxiliary machine 4, an inverter 5 (PDU), a DC-DC converter 6, electric power supply circuits 11P and 11N, auxiliary machine drive circuits 12P and 12N, DC power supply circuits 13P and 13N, a branch circuit 14, and a control unit 10.

As illustrated in FIGS. 1 to 3, the battery 2 includes a first power storage unit 21, a second power storage unit 22, first to sixth contactors M/C_A, S/C_A, S/C_B, S/C_C, P/C_A and P/C_B, first and second resistors R1 and R2, a current sensor IS, and a current breaker FUSE.

The first power storage unit 21 and the second power storage unit 22 are battery modules which can perform charging and discharging of 400 V.

The first contactor M/C_A is provided on a positive electrode side end of the battery 2 and functions as a main switch which turns on and off connection to the outside (electric power supply circuit 11P) of the battery 2.

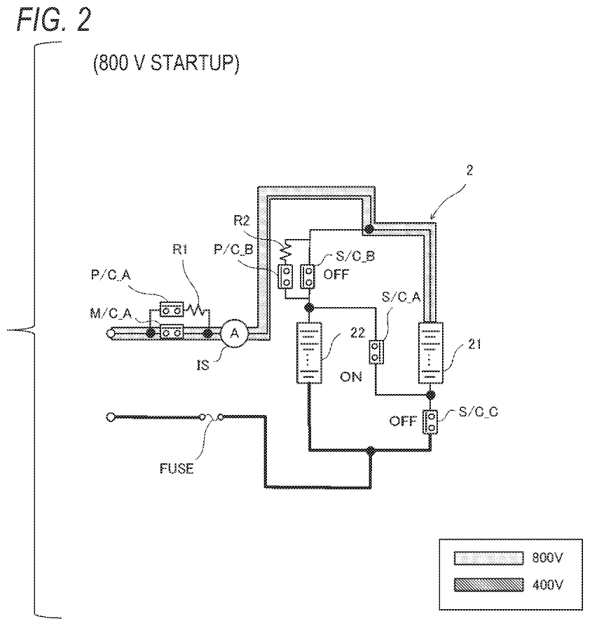

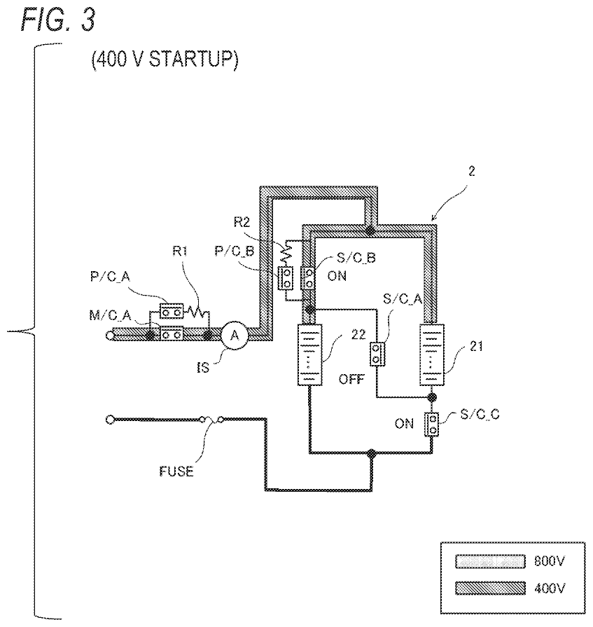

The second to fourth contactors S/C_A. S/C_B, and S/C_C switch a connection state between the first power storage unit 21 and the second power storage unit 22. For example, as illustrated in FIG. 2, when the second contactor S/C_A is turned on whereas the third contactor S/C_B and the fourth contactor S/C_C are turned off the battery 2 is in a first voltage state (800 V startup) in which the first power storage unit 21 and the second power storage unit 22 are connected in series, so that the battery 2 can perform charging and discharging at 800 V. In addition, as illustrated in FIG. 3, when the second contactor S/C_A is turned off whereas the third contactor S/C_B and the fourth contactor S/C_C are turned on, the battery 2 is in a second voltage state (400 V startup) in which the first power storage unit 21 and the second power storage unit 22 are connected in parallel, so that the battery 2 can perform charging and discharging at 400 V. The term startup refers to a concept including driving during traveling of the electric vehicle having the power storage system 1 and charging during stopping of the electric vehicle. The second to fourth contactors S/C_A. S/C_B, and S/C_C are an example of a first switch unit configured to switch between the first voltage state (800 V startup) and the second voltage state (400 V startup).

The fifth contactor P/C_A and the first resistor R1 are disposed in series and are disposed in parallel with the first contactor M/C_A. In the first voltage state and the second voltage state, the fifth contactor P/C_A is turned on before the first contactor M/C_A is turned on, thereby protecting the first contactor M/C_A from an excessive inrush current.

The sixth contactor P/C_B and the second resistor R2 are disposed in series and are disposed in parallel with the third contactor S/C_B. In the second voltage state, the sixth contactor P/C_B is turned on before the third contactor S/C_B is turned on, thereby protecting the third contactor S/C_B from an excessive inrush current.

The current sensor IS is provided between the first contactor M/C_A and the power storage units 21 and 22 to measure a current.

The current breaker FUSE is provided on a negative electrode side end of the battery 2 and cuts off the connection to the outside (electric power supply circuit 11N) of the battery 2 when an abnormality occurs. In the power storage system 1 according to the present embodiment, the current breaker FUSE is implemented by a pyro-fuse which can intentionally cut off a current according to an electric signal. When an abnormality occurs (for example, vehicle collision or short-circuit in the battery 2), the current breaker FUSE performs a cut-off operation, and all the contactors in the battery 2 are turned off (opened).

Accordingly, when an abnormality occurs, the connection to the outside can be cut off on both the positive and negative end sides of the battery 2. Additionally, in both the first voltage state (800 V startup) and the second voltage state (400 V startup), reliable circuit cut-off can be performed by turning off the plurality of contactors on the circuit even when contactor welding occurs. Further, since a pyro-fuse is used as the current breaker FUSE, it is not necessary to provide a contactor on the negative electrode side end of the battery 2, and thus the number of components and a cost can be reduced.

The three-phase motor 3 includes three-phase coils 32U, 32V, and 32W, one end side of each of which is connected to a neutral point 31. The three-phase motor 3 is rotationally driven by electric power supplied from the battery 2 via the inverter 5. The three-phase motor 3 in the present embodiment includes a U-phase terminal 33U, a V-phase terminal 33V, and a W-phase terminal 33W, each of which is connected to the other end side of each of the coils 32U, 32V, and 32W, respectively, and a neutral point terminal 34 connected to the neutral point 31. The U-phase terminal 33U, the V-phase terminal 33V, and the W-phase terminal 33W are connected to the inverter 5, and the neutral point terminal 34 is connected to the branch circuit 14.

The inverter 5 converts DC electric power supplied from the battery 2 into three-phase AC electric power by switching a plurality of switching elements and rotationally drives the three-phase motor 3. When a DC (400 V) is supplied from the branch circuit 14 to the neutral point 31 of the three-phase motor 3, the inverter 5 can function as a booster circuit by switching the plurality of switching elements to boost the DC (to 800 V) using the coils 32U, 32V, and 32W. That is, the coils 32U, 32V, and 32W wound around a stator core are used as transformers. The inverter 5 allows a current to flow from the three-phase motor 3 to the battery side regardless of on and off of a gate, and allows a current to flow from the battery side to the three-phase motor 3 only when the gate is on.

The auxiliary machine 4 is a high-voltage driven in-vehicle device which can be driven by DC electric power from the battery 2 and an external power supply. For example, the auxiliary machine 4 includes an electric compressor or a heater for air-conditioning. The auxiliary machine 4 is connected to the battery 2 via the auxiliary machine drive circuits 12P and 12N, a seventh contactor VS/C, and the electric power supply circuits 11P and 11N, which will be described later. The seventh contactor VS/C is an example of a third switch unit. The auxiliary machine 4 in the present embodiment is operated at the base voltage of 800 V.

The DC-DC converter 6 steps down DC electric power from the battery 2 and the external power supply to drive a low-voltage drive in-vehicle device. The DC-DC converter 6 is provided with an ammeter (not illustrated).

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary machine drive circuits 12P and 12N (auxiliary machine 4) on a side closer to the inverter 5 than the connection portions 111P and 111N. The electric power supply circuit 11P on the positive electrode side is provided with the seventh contactor VS/C which turns on and off the circuit between the connection portion 112P connected to the auxiliary machine drive circuit 12P and the connection portion 111P connected to the DC power supply circuit 13P. A first voltage sensor V_PIN and a first smoothing capacitor C1 are provided in the electric power supply circuits 11P and 11N on a side close to the inverter 5, and a second smoothing capacitor C2 is further provided between the electric power supply circuit 11N on the negative electrode side and the branch circuit 14.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the connection portions 111P and 111N. The DC power supply circuits 13P and 13N are provided with an eighth contactor QC/C_A and a ninth contactor QC/C_B for turning on and off the respective circuits, a second voltage sensor V_BAT at a position closer to the connection portions 111P and 111N than the eighth contactor QC/C_A and the ninth contactor QC/C_B, and a third voltage sensor V_QC at a position closer to the charge terminals 131P and 131N than the eighth contactor QC/C_A and the ninth contactor QC/C_B.

The branch circuit 14 is branched, in the DC power supply circuit 13P on the positive electrode side, at a position closer to the connection portion 111P than the eighth contactor Q/C_A and the second voltage sensor V_BAT and is connected to the neutral point 31 (neutral point terminal 34) of the three-phase motor 3. An intermediate portion of the branch circuit 14 is provided with a tenth contactor QC/C_C for turning on and off the circuit. The tenth contactor QC/C_C is an example of a second switch unit.

The control unit 10 is, for example, a vehicle ECU and controls driving and charging of the power storage system 1. More specifically, the control unit 10 performs on and off control of the first to tenth contactors M/C_A, S/C_A, S/C_B, S/C_C, P/C_A, P/C_B. VS/C, QC/C_A. QC/C_B, and QC/C_C, detection of welding of these contactors, and control of the DC-DC converter 6 and the inverter 5.

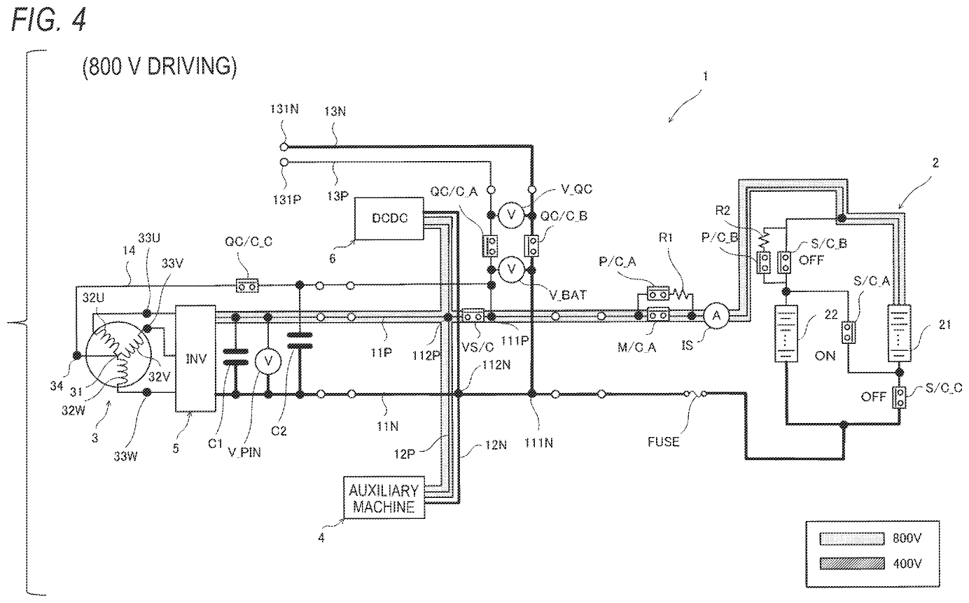

Next, an operation of the power storage system 1 will be described with reference to FIGS. 4 to 9.

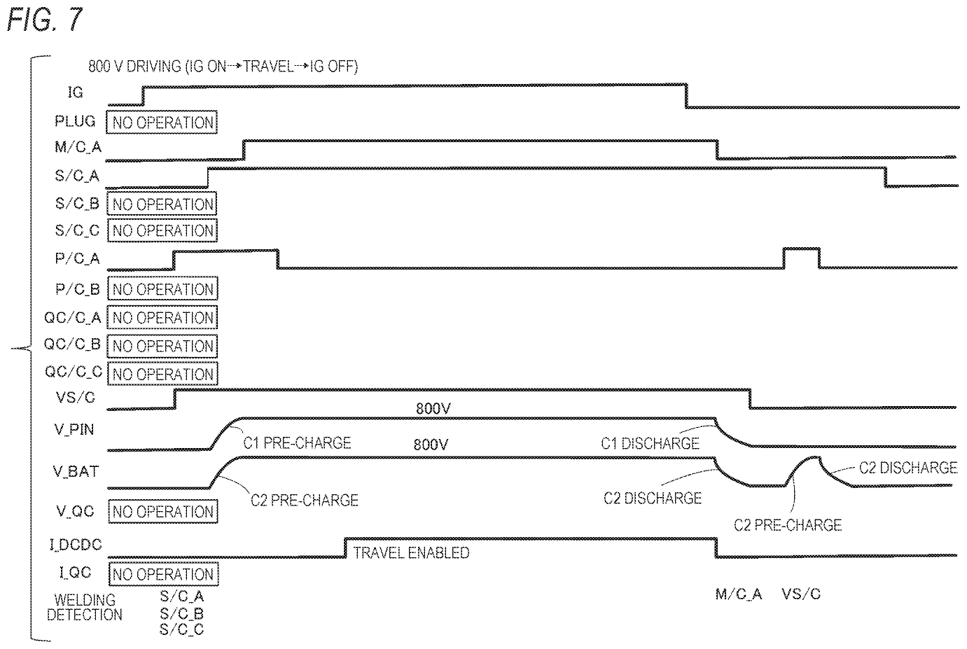

FIG. 4 illustrates a flow of a current during traveling (800 V driving) of the electric vehicle including the power storage system 1 according to the first embodiment, and FIG. 7 illustrates an operation sequence during the traveling (800 V driving) of the electric vehicle including the power storage system 1 according to the first embodiment.

When an ignition switch IG of the electric vehicle is turned on, the control unit 10 first turns on the fifth contactor P/C_A and the seventh contactor VS/C and checks detected voltage values of the first voltage sensor V_PIN and the second voltage sensor V_BAT. When the detected voltage values of the first voltage sensor V_PIN and the second voltage sensor V_BAT increase, the control unit 10 determines that any one of the second to fourth contactors S/C_A. S/C_B, and S/C_C is welded and performs abnormality notification.

When the control unit 10 determines that the second to fourth contactors S/C_A, S/C_B, and S/C_C are not welded, the control unit 10 turns on the second contactor S/C_A and connects the circuit in the battery 2 in the first voltage state (800 V). When the circuit in the battery 2 is connected in the first voltage state (800 V), the first smoothing capacitor C1 and the second smoothing capacitor C2 are pre-charged and the detected voltage values of the first voltage sensor V_PIN and the second voltage sensor V_BAT gradually increase.

The control unit 10 turns on the first contactor M/C_A to activate the battery 2 in the first voltage state (800 V) at a timing when the pre-charging of the first smoothing capacitor C1 and the second smoothing capacitor C2 is completed, and then turns off the fifth contactor P/C_A. Accordingly, travel of the electric vehicle is enabled. At this time, the auxiliary machine 4 is connected to the electric power supply circuits 11P and 11N via the auxiliary machine drive circuits 12P and 12N and is driven by the first voltage (800 V) supplied from the battery 2.

On the other hand, when the ignition switch IG is turned off, the control unit 10 first turns off the first contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the control unit 10 determines that the first contactor M/C_A is welded, and performs abnormality notification.

When the control unit 10 determines that the first contactor M/C_A is not welded, the control unit 10 turns off the seventh contactor VS/C at a timing when the discharging of the first and second smoothing capacitors C1 and C2 is completed. The control unit 10 then turns on the fifth contactor P/C_A and checks the detected voltage value of the first voltage sensor V_PIN. When the detected voltage value of the first voltage sensor V_PIN increases, the control unit 10 determines that the seventh contactor VS/C is welded and performs abnormality notification.

When the control unit 10 determines that the seventh contactor VS/C is not welded, the control unit 10 turns off the fifth contactor P/C_A and the second contactor S/C_A and ends the operation sequence during traveling.

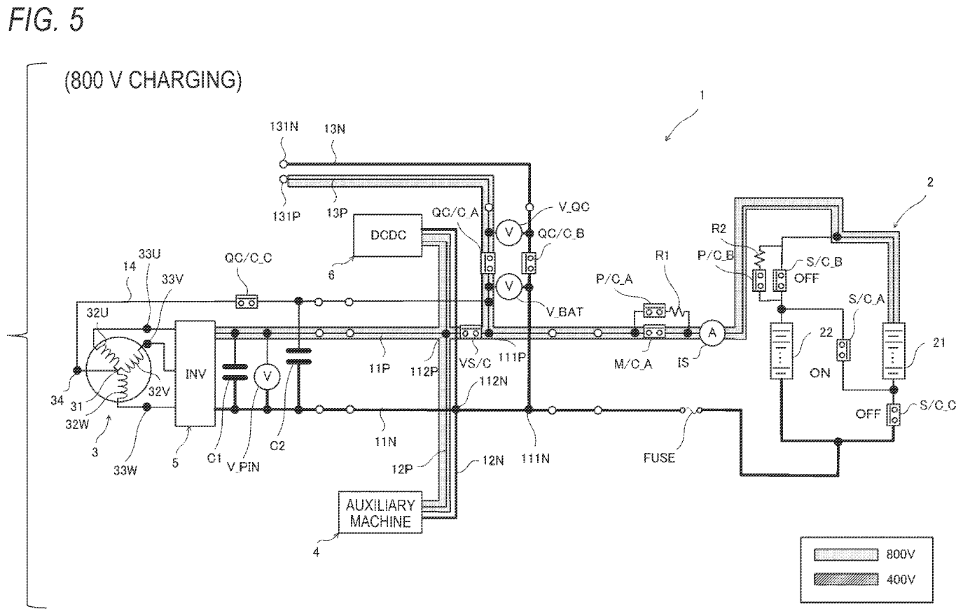

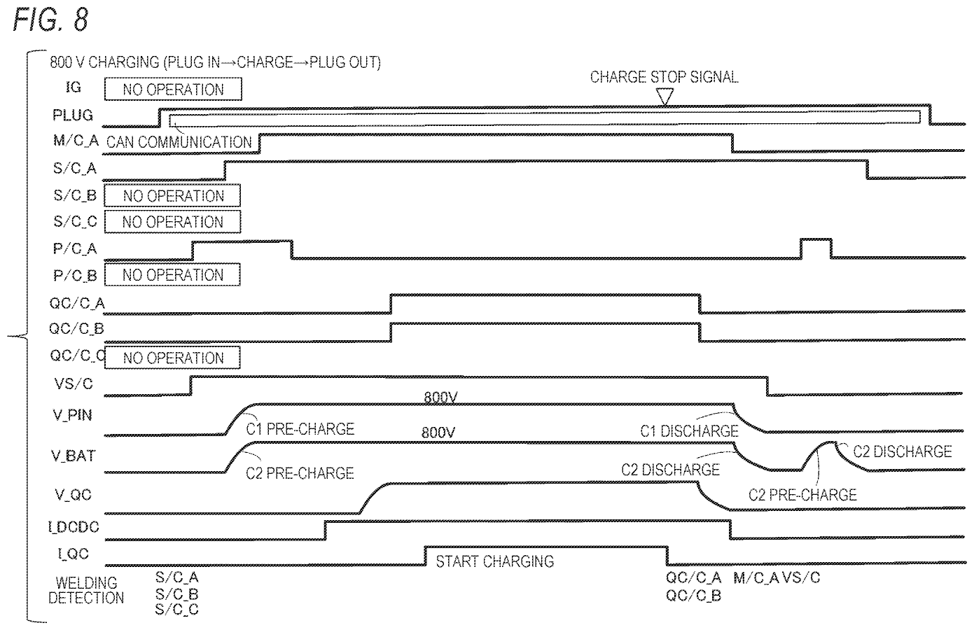

FIG. 5 illustrates a flow of a current during first-voltage charging (800 V charging) of the electric vehicle including the power storage system 1 according to the first embodiment, and FIG. 8 illustrates an operation sequence during the first-voltage charging (800 V charging) of the electric vehicle including the power storage system 1 according to the first embodiment.

When a charge plug is connected to the charge terminals 131P and 131N, the control unit 10 performs CAN communication with charging equipment to recognize a charge voltage. When the charge voltage is the first voltage (800 V), the control unit 10 first turns on the fifth contactor P/C_A and the seventh contactor VS/C and checks the detected voltage values of the first voltage sensor V_PIN and the second voltage sensor V_BAT. When the detected voltage values of the first voltage sensor V_PIN and the second voltage sensor V_BAT increase, the control unit 10 determines that any one of the second to fourth contactors S/C_A, S/C_B. and S/C_C is welded and performs abnormality notification.

When the control unit 10 determines that the second to fourth contactors S/C_A, S/C_B, and S/C_C are not welded, the control unit 10 turns on the second contactor S/C_A and connects the circuit in the battery 2 in the first voltage state (800 V). When the circuit in the battery 2 is connected in the first voltage state (800 V), the first smoothing capacitor C1 and the second smoothing capacitor C2 are pre-charged and the detected voltage values of the first voltage sensor V_PIN and the second voltage sensor V_BAT gradually increase.

The control unit 10 turns on the first contactor M/C_A to activate the battery 2 in the first voltage state (800 V) at a timing when the pre-charging of the first smoothing capacitor C1 and the second smoothing capacitor C2 is completed, and then turns off the fifth contactor P/C_A. Accordingly, the battery 2 is in a state in which charging with the first voltage (800 V) can be started.

Thereafter, the control unit 10 turns on the eighth contactor QC/C_A and the ninth contactor QC/C_B to start charging the battery 2 with the first voltage (800 V). At this time, the auxiliary machine 4 is connected to the DC power supply circuits 13P and 13N via the auxiliary machine drive circuits 12P and 12N and the seventh contactor VS/C and is driven by the first voltage (800 V) supplied from the charging equipment.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 turns off the first contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the control unit 10 determines that the first contactor M/C_A is welded, and performs abnormality notification.

When the control unit 10 determines that the first contactor M/C_A is not welded, the control unit 10 turns off the seventh contactor VS/C at a timing when the discharging of the first and second smoothing capacitors C1 and C2 is completed. The control unit 10 then turns on the fifth contactor P/C_A and checks the detected voltage value of the first voltage sensor V_PIN. When the detected voltage value of the first voltage sensor V_PIN increases, the control unit 10 determines that the seventh contactor VS/C is welded and performs abnormality notification.

When the control unit 10 determines that the seventh contactor VS/C is not welded, the control unit 10 turns off the fifth contactor P/C_A and the second contactor S/C_A and ends the operation sequence during the first-voltage (800 V) charging.

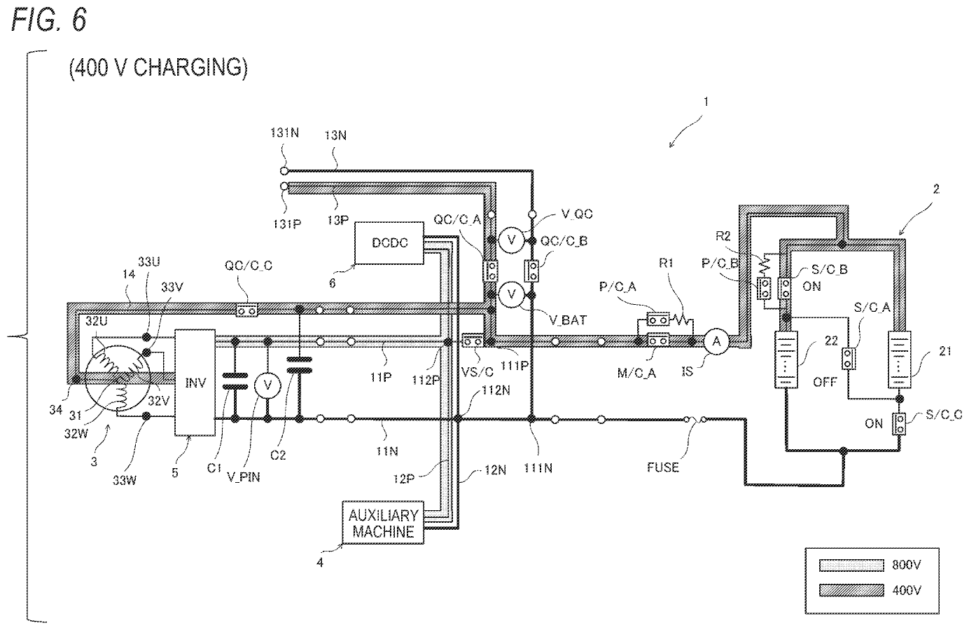

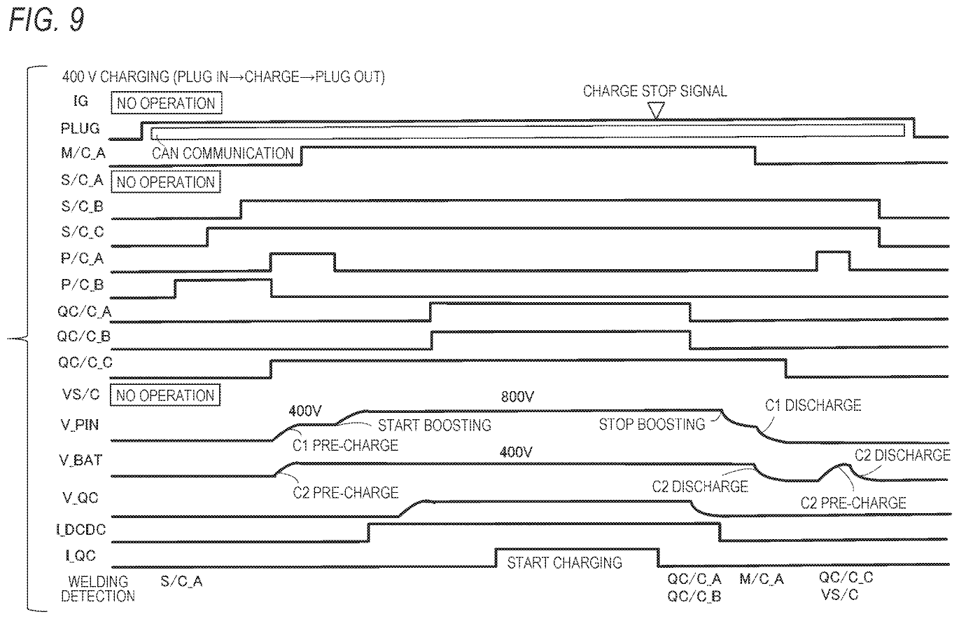

FIG. 6 illustrates a flow of a current during second-voltage charging (400 V charging) of the electric vehicle including the power storage system 1 according to the first embodiment, and FIG. 9 illustrates an operation sequence during the second-voltage charging (400 V charging) of the electric vehicle including the power storage system 1 according to the first embodiment.

When a charge plug is connected to the charge terminals 131P and 131N, the control unit 10 performs CAN communication with charging equipment to recognize a charge voltage. When the charge voltage is the second voltage (400 V), the control unit 10 first turns on the sixth contactor P/C_B and checks a change in a voltage sensor (CVS) (not illustrated) mounted on the first power storage unit 21. When the voltage sensor (CVS) changes, the control unit 10 determines that the second contactor S/C_A is welded and performs abnormality notification.

When the control unit 10 determines that the second contactor S/C_A is not welded, the control unit 10 turns on the fourth contactor S/C_C, then turns on the third contactor S/C_B and connects the circuit in the battery 2 in the second voltage state (400 V). Thereafter, the control unit 10 turns off the sixth contactor P/C_B, turns on the fifth contactor P/C_A and the tenth contactor QC/C_C to enable the boosting circuit implemented by the three-phase motor 3 and the inverter 5. Next, the control unit 10 turns on the first contactor M/C_A to activate the battery 2 in the second voltage state (400 V) and then turns off the fifth contactor P/C_A. Accordingly, the battery 2 is in a state in which charging with the second voltage (400 V) can be started.

Thereafter, the control unit 10 turns on the eighth contactor QC/C_A and the ninth contactor QC/C_B to start charging the battery 2 with the second voltage (400 V). At this time, the three-phase motor 3 and the inverter 5 connected to the DC power supply circuits 13P and 13N via the branch circuit 14 boost the second voltage (400 V) supplied from the charging equipment to the first voltage (800 V) to drive the auxiliary machine 4.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 stops the boosting performed by the three-phase motor 3 and the inverter 5, then turns off the first contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the control unit 10 determines that the first contactor M/C_A is welded, and performs abnormality notification.

When the control unit 10 determines that the first contactor M/C_A is not welded, the control unit 10 turns off the tenth contactor QC/C_C at a timing when the discharging of the first and second smoothing capacitors C1 and C2 is completed. The control unit 10 then turns on the fifth contactor P/C_A and checks the detected voltage value of the first voltage sensor V_PIN. When the detected voltage value of the first voltage sensor V_PIN increases, the control unit 10 determines that any one of the tenth contactor QC/C_C and the seventh contactor VS/C is welded and performs abnormality notification.

When the control unit 10 determines that the tenth contactor QC/C_C and the seventh contactor VS/C are not welded, the control unit 10 turns off the fifth contactor P/C_A, the third contactor S/C_B, and the fourth contactor S/C_C, and ends the operation sequence during the second-voltage (400 V) charging.

### Second Embodiment

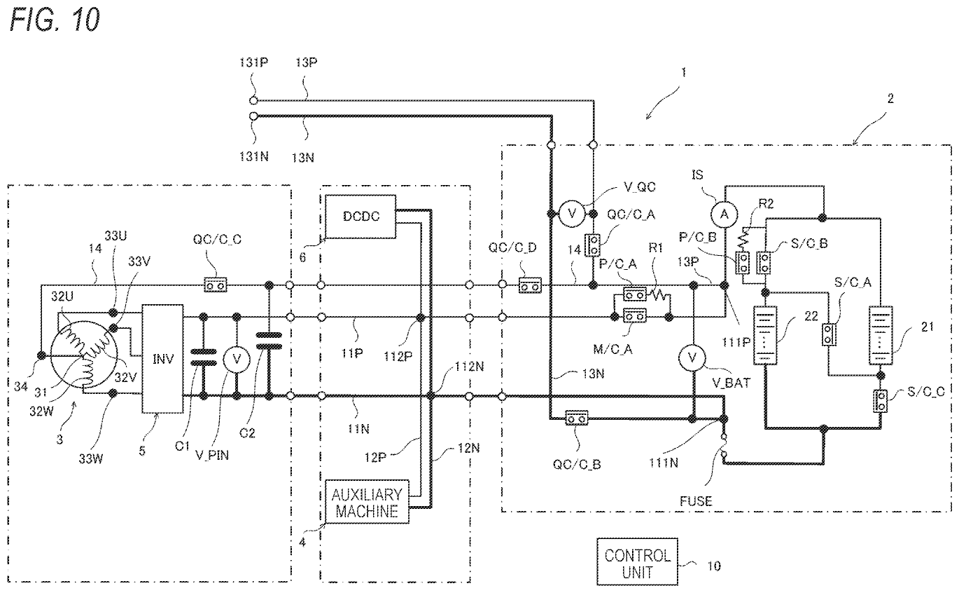

Next, a power storage system 1 according to a second embodiment will be described with reference to FIGS. 10 to 16. Here, the same reference numerals as in the first embodiment are used for the same configurations as in the first embodiment, and the description of the first embodiment may be incorporated.

In the power storage system 1 according to the first embodiment, the eighth contactor QC/C_A which is a main switch for charging is connected in series to the first contactor M/C_A which is the main switch of the battery 2. However, in the power storage system 1 according to the second embodiment, the eighth contactor QC/C_A is connected in parallel to the first contactor M/C_A as illustrated in FIG. 10.

In the power storage system 1 according to the second embodiment, the same effect as those of the power storage system 1 according to the first embodiment can be obtained based on an operation according to an operation sequence to be described later. In addition, in the power storage system 1 according to the second embodiment, during the second-voltage (400 V) charging, the battery 2 charged with the second voltage (400 V) can be separated, by the first contactor M/C_A, from the first voltage (800 V) boosted by the three-phase motor 3 and the inverter 5, and thus no switch component corresponding to the seventh contactor VS/C in the first embodiment is required.

The second embodiment is similar to the first embodiment in that the second to fourth contactors S/C_A, S/C_B, and S/C_C are an example of the first switch unit and the tenth contactor QC/C_C is an example of the second switch unit. However, the second embodiment is different from the first embodiment in that the first contactor M/C_A is an example of the third switch unit.

In the power storage system 1 according to the second embodiment, it is assumed that the eighth contactor QC/C_A, the ninth contactor QC/C_B, the second voltage sensor V_BAT, and the third voltage sensor V_QC are disposed in the battery 2 and the branch circuit 14 is drawn out from inside the battery 2. Therefore, an eleventh contactor QC/C_D is provided in the battery 2 at a position closer to the inverter 5 than a position in the vicinity of the branch of the branch circuit 14 in order to cut off connection with the outside of the battery when an abnormality occurs.

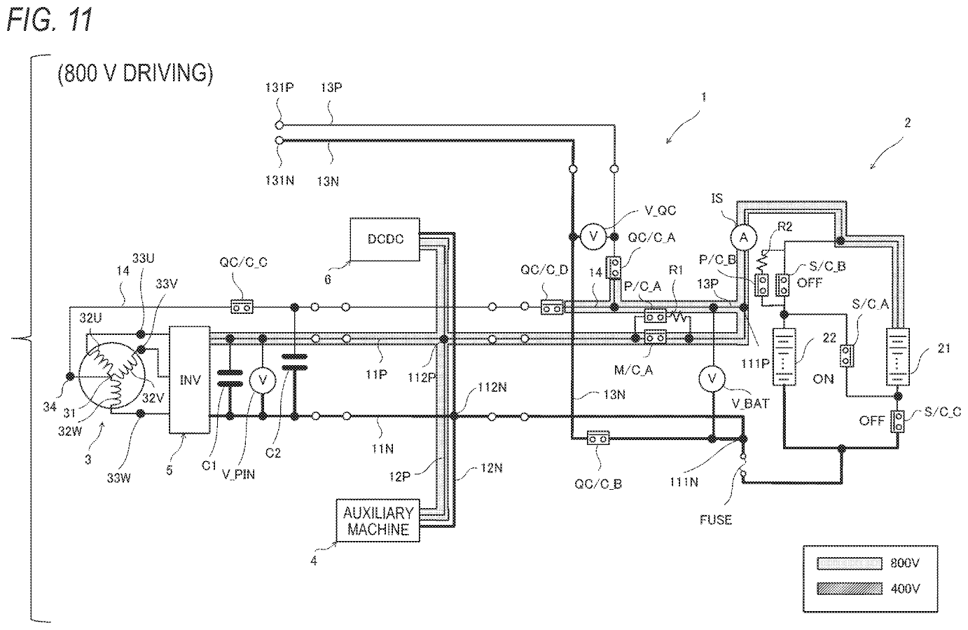

Next, an operation of the power storage system 1 according to the second embodiment will be described with reference to FIGS. 11 to 16.

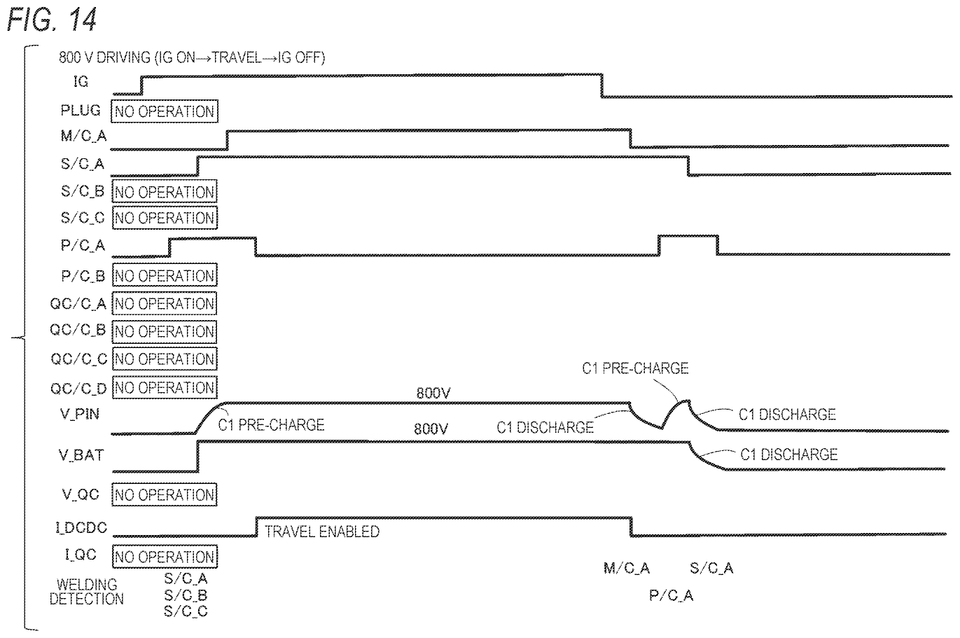

FIG. 11 illustrates a flow of a current during traveling (800 V driving) of the electric vehicle including the power storage system 1 according to the second embodiment, and FIG. 14 illustrates an operation sequence during the traveling (800 V driving) of the electric vehicle including the power storage system 1 according to the second embodiment.

When the ignition switch IG of the electric vehicle is turned on, the control unit 10 checks the detected voltage value of the second voltage sensor V_BAT. When the detected voltage value of the second voltage sensor V_BAT increases, the control unit 10 determines that any one of the second to fourth contactors S/C_A. S/C_B, and S/C_C is welded, and performs abnormality notification.

When the control unit 10 determines that there is no welding, the control unit 10 turns on the fifth contactor P/C_A, then turns on the second contactor S/C_A and connects the circuit in the battery 2 in the first voltage state (800 V). When the circuit in the battery 2 is connected in the first voltage state (800 V), the first smoothing capacitor C1 is pre-charged, and the detected voltage value of the first voltage sensor V_PIN gradually increases. The control unit 10 turns on the first contactor M/C_A to activate the battery 2 in the first voltage state (800 V) at a timing when the pre-charging of the first smoothing capacitor C1 is completed, and then turns off the fifth contactor P/C_A. Accordingly, travel of the electric vehicle is enabled. At this time, the auxiliary machine 4 is connected to the electric power supply circuits 11P and 11N via the auxiliary machine drive circuits 12P and 12N and is driven by the first voltage (800 V) supplied from the battery 2.

On the other hand, when the ignition switch IG is turned off, the control unit 10 first turns off the first contactor M/C_A and checks the detected voltage value of the first voltage sensor V_PIN. When the detected voltage value of the first voltage sensor V_PIN does not decrease due to discharging of the first smoothing capacitor C1, the control unit 10 determines that the first contactor M/C_A is welded and performs abnormality notification.

When the control unit 10 determines that the first contactor M/C_A is not welded, the control unit 10 turns on the fifth contactor P/C_A at a timing when the discharging of the first smoothing capacitor C1 is completed, and checks the detected voltage value of the first voltage sensor V_PIN. When the detected voltage value of the first voltage sensor V_PIN does not gradually increase, the control unit 10 detects disconnection of the fifth contactor P/C_A. After the first smoothing capacitor C1 is charged again, the second contactor S/C_A is turned off and the detected voltage values of the first voltage sensor V_PIN and the second voltage sensor V_BAT are checked. When the detected voltage values of the first voltage sensor V_PIN and the second voltage sensor V_BAT do not decrease due to the discharging of the first smoothing capacitor C1, the control unit 10 determines that the second contactor S/C_A is welded, and performs abnormality notification.

When the control unit 10 determines that the second contactor S/C_A is not welded, the control unit 10 turns off the fifth contactor P/C_A and ends the operation sequence during traveling.

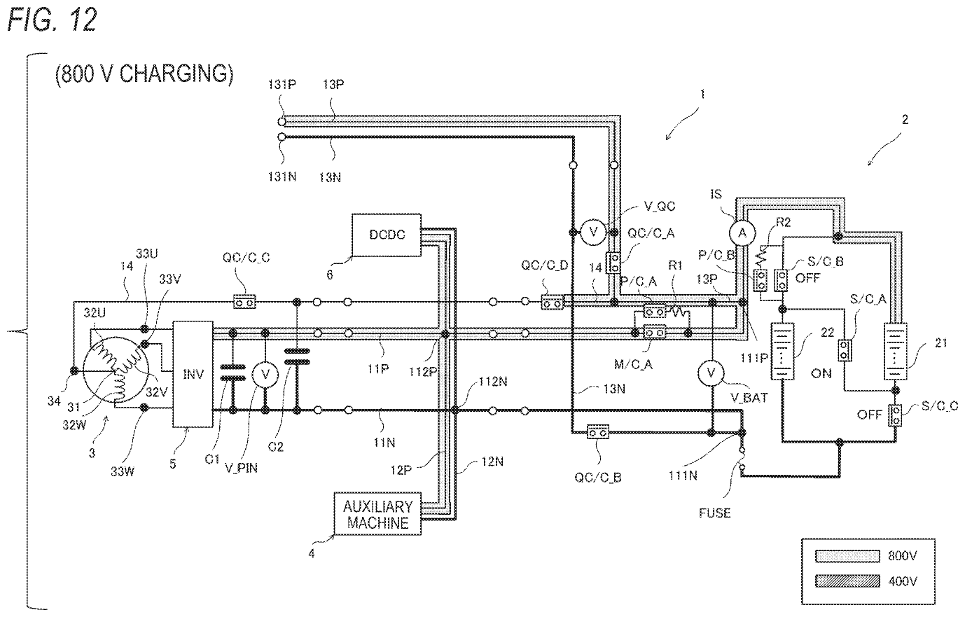

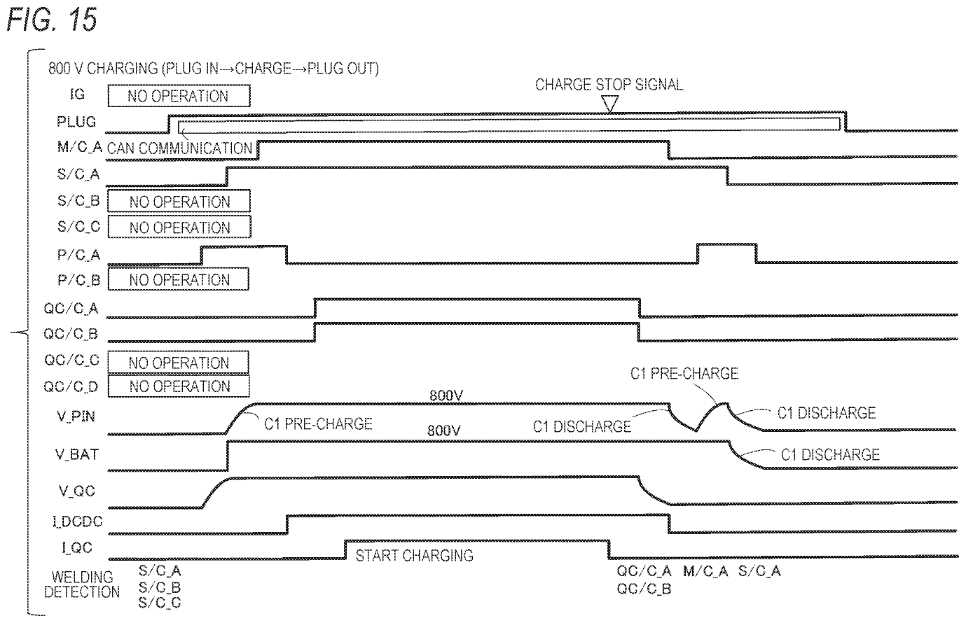

FIG. 12 illustrates a flow of a current during first-voltage charging (800 V charging) of the electric vehicle including the power storage system 1 according to the second embodiment, and FIG. 15 illustrates an operation sequence during the first-voltage charging (800 V charging) of the electric vehicle including the power storage system 1 according to the second embodiment.

When a charge plug is connected to the charge terminals 131P and 131N, the control unit 10 performs CAN communication with the charging equipment to recognize a charge voltage, and checks the detected voltage value of the second voltage sensor V_BAT.

When the detected voltage value of the second voltage sensor V_BAT increases, the control unit 10 determines that any one of the second to fourth contactors S/C_A, S/C_B, and S/C_C is welded, and performs abnormality notification.

When the control unit 10 determines that the charge voltage is the first voltage (800 V) and there is no welding, the control unit 10 turns on the fifth contactor P/C_A, then turns on the second contactor S/C_A and connects the circuit in the battery 2 in the first voltage state (800 V). When the circuit in the battery 2 is connected in the first voltage state (800 V), the first smoothing capacitor C1 is pre-charged, and the detected voltage value of the first voltage sensor V_PIN gradually increases. The control unit 10 turns on the first contactor M/C_A to activate the battery 2 in the first voltage state (800 V) at a timing when the pre-charging of the first smoothing capacitor C1 is completed, and then turns off the fifth contactor P/C_A. Accordingly, the battery 2 is in a state in which charging with the first voltage (800 V) can be started.

Thereafter, the control unit 10 turns on the eighth contactor QC/C_A and the ninth contactor QC/C_B to start charging the battery 2 with the first voltage (800 V). At this time, the auxiliary machine 4 is connected to the DC power supply circuits 13P and 13N via the auxiliary machine drive circuits 12P and 12N and the first contactor M/C_A and is driven by the first voltage (800 V) supplied from the charging equipment.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 turns off the first contactor M/C_A and checks the detected voltage value of the first voltage sensor V_PIN. When the detected voltage value of the first voltage sensor V_PIN does not decrease due to discharging of the first smoothing capacitor C1, the control unit 10 determines that the first contactor M/C_A is welded and performs abnormality notification.

When the control unit 10 determines that the first contactor M/C_A is not welded, the control unit 10 turns on the fifth contactor P/C_A at a timing when the discharging of the first smoothing capacitor C1 is completed, charges the first smoothing capacitor C1 again, then turns off the second contactor S/C_A and checks the detected voltage values of the first voltage sensor V_PIN and the second voltage sensor V_BAT. When the detected voltage values of the first voltage sensor V_PIN and the second voltage sensor V_BAT do not decrease due to the discharging of the first smoothing capacitor C1, the control unit 10 determines that the second contactor S/C_A is welded, and performs abnormality notification.

When the control unit 10 determines that the second contactor S/C_A is not welded, the control unit 10 turns off the fifth contactor P/C_A and ends the operation sequence during the first-voltage (800 V) charging.

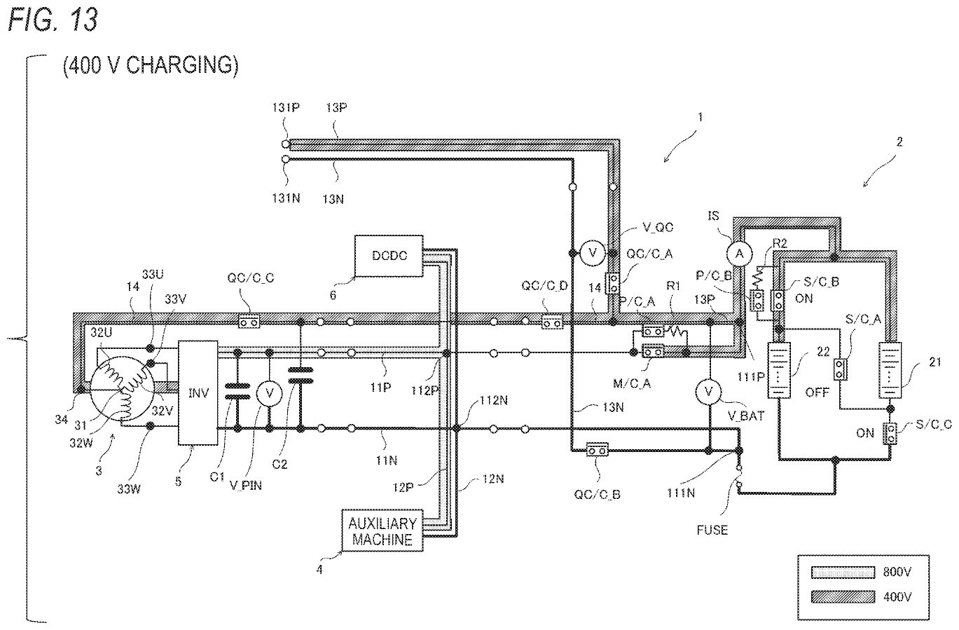

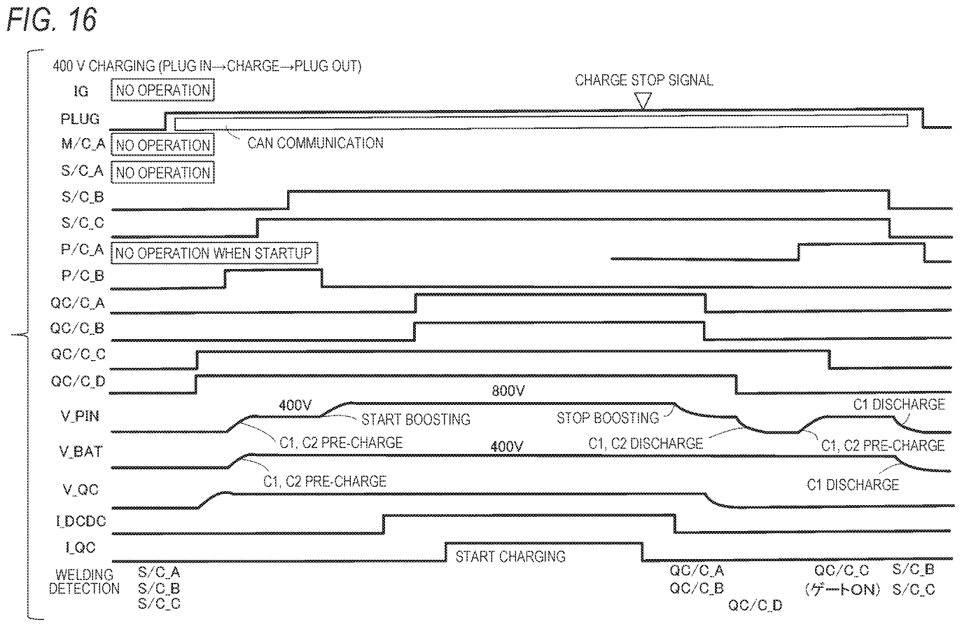

FIG. 13 illustrates a flow of a current during second-voltage charging (400 V charging) of the electric vehicle including the power storage system 1 according to the second embodiment, and FIG. 16 illustrates an operation sequence during the second-voltage charging (400 V charging) of the electric vehicle including the power storage system 1 according to the second embodiment.

When a charge plug is connected to the charge terminals 131P and 131N, the control unit 10 performs CAN communication with the charging equipment to recognize a charge voltage, and checks the detected voltage value of the second voltage sensor V_BAT. When the detected voltage value of the second voltage sensor V_BAT increases, the control unit 10 determines that any one of the second to fourth contactors S/C_A, S/C_B, and S/C_C is welded, and performs abnormality notification.

When the control unit 10 determines that the charge voltage is the second voltage (400 V) and there is no welding, the control unit 10 turns on the tenth contactor QC/C_C and the eleventh contactor QC/C_D, then turns on the sixth contactor P/C_B and pre-charges the first and second smoothing capacitors C1 and C2. The control unit 10 turns on the fourth contactor S/C_C at a timing when the pre-charging of the first and second smoothing capacitors C1 and C2 is completed, then turns on the third contactor S/C_B, connects the circuit in the battery 2 in the second voltage state (400 V) and then turns off the sixth contactor P/C_B. Accordingly, the battery 2 is in a state in which charging with the second voltage (400 V) can be started.

Thereafter, the control unit 10 turns on the eighth contactor QC/C_A and the ninth contactor QC/C_B to start charging the battery 2 with the second voltage (400 V). At this time, the three-phase motor 3 and the inverter 5 connected to the DC power supply circuits 13P and 13N via the branch circuit 14 boost the second voltage (400 V) supplied from the charging equipment to the first voltage (800 V) to drive the auxiliary machine 4.

On the other hand, when the control unit 10 determines that a charge stop signal is received, the control unit 10 turns off the eighth contactor QC/C_A and the ninth contactor QC/C_B and checks a detected voltage value of the third voltage sensor V_QC. When the detected voltage value of the third voltage sensor V_QC does not decrease, the control unit 10 determines that the eighth contactor QC/C_A and the ninth contactor QC/C_B are welded and performs abnormality notification.

When the control unit 10 determines that the eighth contactor QC/C_A and the ninth contactor QC/C_B are not welded, the control unit 10 turns off the eleventh contactor QC/C_D and checks the detected voltage value of the first voltage sensor V_PIN. When the detected voltage value of the first voltage sensor V_PIN does not decrease due to discharging of the first and second smoothing capacitors C1 and C2, the control unit 10 determines that the eleventh contactor QC/C_D is welded, and performs abnormality notification.

When the control unit 10 determines that the eleventh contactor QC/C_D is not welded, the control unit 10 turns on the fifth contactor P/C_A at a timing when the discharging of the first and second smoothing capacitors C1 and C2 is completed, charges the first and second smoothing capacitors C1 and C2 again, then turns off the tenth contactor QC/C_C and checks the detected voltage value of the first voltage sensor V_PIN. When the detected voltage value of the first voltage sensor V_PIN decreases since a gate of the inverter 5 is turned on, the control unit 10 determines that the tenth contactor QC/C_C is welded, and performs abnormality notification. When the control unit 10 determines that the tenth contactor QC/C_C is not welded, the control unit 10 turns off the third contactor S/C_B and the fourth contactor S/C_C and checks the detected voltage values of the first voltage sensor V_PIN and the second voltage sensor V_BAT. When the detected voltage values of the first voltage sensor V_PIN and the second voltage sensor V_BAT do not decrease due to the discharging of the first smoothing capacitor C1, the control unit 10 determines that any one of the third contactor S/C_B and the fourth contactor S/C_C is welded, and performs abnormality notification.

When the control unit 10 determines that the third contactor S/C_B and the fourth contactor S/C_C are not welded, the control unit 10 turns off the fifth contactor P/C_A and ends the operation sequence during the second-voltage (400 V) charging.

Although various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiments may be freely combined without departing from the gist of the invention.

In the present specification, at least the following matters are described. Although corresponding constituent elements or the like in the above-described embodiments are shown in parentheses, the present invention is not limited thereto.
(1) A power storage system (power storage system 1) including:
a battery (battery 2) including a first power storage unit (first power storage unit 21), a second power storage unit (second power storage unit 22), and a first switch unit (second contactor S/C_A, third contactor S/C_B, and fourth contactor S/C_C), the first switch unit being configured to switch between a first voltage state, in which the first power storage unit and the second power storage unit are connected in series and chargeable at a first voltage, and a second voltage state in which the first power storage unit and the second power storage unit are connected in parallel and chargeable at a second voltage;
a three-phase motor (three-phase motor 3) in which coils (coils 32U, 32V, and 32W) of three phases are connected at a neutral point (neutral point 31), the three-phase motor being driven by electric power supplied from the battery;
an inverter (inverter 5) connected on an electric power transmission path (electric power supply circuits 1l P and 11N) between the battery and the three-phase motor; and
a DC power supply circuit (DC power supply circuits 13P and 13N) connected to a connection portion (connection portions 111P and 111N) located on an electric power transmission path between the inverter and the battery, in which
the DC power supply circuit includes a branch circuit (branch circuit 14) connected to the neutral point on a positive electrode side.

According to (1), it is possible to appropriately perform charging according to a voltage state of charging equipment by switching, by the first switch unit, a mode of connection between the first power storage unit and the second power storage unit both in a system in which the external charging equipment performs charging at the first voltage or a system in which the external charging equipment performs charging at the second voltage. That is, charging can be performed without passing through any voltage converter during charging, efficiency deterioration due to the voltage converter can be avoided, and need for the voltage converter for charging can be eliminated.

In addition, since the positive-electrode-side DC power supply circuit connected to the connection portion located on the electric power transmission path between the inverter and the battery includes the branch circuit connected to the neutral point of the three-phase motor, voltage conversion can be performed using the three-phase motor and the inverter. Accordingly, even when the voltage state of the charging equipment is different from an operating voltage of an auxiliary machine or the like, need for a dedicated voltage converter can be eliminated, and thus a manufacturing cost can be reduced.
(2) The power storage system according to (1), in which
the branch circuit is connected to the neutral point via a second switch unit (tenth contactor QC/C_C).

According to (2), when the three-phase motor does not perform voltage conversion, that is, when the coils of the three-phase motor are not used as transformers, connection to the neutral point can be cut off.
(3) The power storage system according to (1), further including:
an auxiliary machine (auxiliary machine 4) configured to be driven by DC electric power from the battery and an external power supply; and
an auxiliary machine drive circuit (auxiliary machine drive circuits 12P and 12N) connected on an electric power transmission path between the inverter and the connection portion and configured to supply electric power to the auxiliary machine, in which
the auxiliary machine is operated at the first voltage.

According to (3), need for voltage conversion is eliminated during traveling and during charging at the first voltage.
(4) The power storage system according to (3), in which
the auxiliary machine is connected to the battery via a third switch unit (seventh contactor VS/C in first embodiment and first contactor M/C_A in second embodiment).

According to (4), when voltage conversion is performed by the three-phase motor, that is, when the coils of the three-phase motor are used as transformers, the third switch unit can separate a portion in the first voltage state from a portion in the second voltage state.
(5) The power storage system according to any one of (1) to (4), further including:
a control unit (control unit 10) configured to control the first switch unit and the inverter, in which
when the battery is charged at the second voltage, the control unit causes the inverter to boost a voltage supplied from the branch circuit to the three-phase motor.

According to (5), since voltage conversion can be performed using the three-phase motor and the inverter, need for an auxiliary machine voltage converter can be eliminated.

What is claimed is:

1. A power storage system comprising:
a battery including a first power storage unit, a second power storage unit, and a first switch unit, the first switch unit being configured to switch between a first voltage state, in which the first power storage unit and the second power storage unit are connected in series and chargeable at a first voltage, and a second voltage state in which the first power storage unit and the second power storage unit are connected in parallel and chargeable at a second voltage;
a three-phase motor in which coils of three phases are connected at a neutral point, the three-phase motor being driven by electric power supplied from the battery;
an inverter connected on an electric power transmission path between the battery and the three-phase motor; and
a DC power supply circuit connected to a connection portion located on an electric power transmission path between the inverter and the battery, wherein
the DC power supply circuit includes a branch circuit connected to the neutral point on a positive electrode side.

2. The power storage system according to claim 1, wherein
the branch circuit is connected to the neutral point via a second switch unit.

3. The power storage system according to claim 1, further comprising:
an auxiliary machine configured to be driven by DC electric power from the battery and an external power supply; and
an auxiliary machine drive circuit connected on an electric power transmission path between the inverter and the connection portion and configured to supply electric power to the auxiliary machine, wherein
the auxiliary machine is operated at the first voltage.

4. The power storage system according to claim 3, wherein
the auxiliary machine is connected to the battery via a third switch unit.

5. The power storage system according to claim 1, further comprising:
a control unit configured to control the first switch unit and the inverter, wherein
when the battery is charged at the second voltage, the control unit causes the inverter to boost a voltage supplied from the branch circuit to the three-phase motor.
